(19) United States
(12) Patent Application Publication
(10) Pub. No.: US 2006/0283085 A1
(43) Pub. Date: Dec. 21, 2006

(54) Actuator

(76) Inventors: Jorg-Peter Mehring, Tauberettersheim (DE); Alexander Eck, Wittighausen (DE)

Correspondence Address: BACHMAN & LAPOINTE, P.C., 900 CHAPEL STREET, SUITE 1201, NEW HAVEN, CT, 06510, US

(21) Appl. No.: 11/443,953

(22) Filed: May 30, 2006

(30) Foreign Application Priority Data
May 31, 2005 (DE) 102005025383.0-32

(51) Int. Cl. E06B 3/68

(52) U.S. Cl. 49/53

(57) ABSTRACT

In the case of an actuator, comprising an electrical drive (1) with a downstream transmission (2), in particular for automatic and electrical closure of doors of a vehicle, in particular of an aircraft, the actuator (R) is intended to have at least one associated electronic name plate (4).

### BACKGROUND OF THE INVENTION

The present invention relates to an actuator comprising an electrical drive with a downstream transmission, in particular for automatic and electrical closure of doors of a vehicle, in particular of an aircraft.

Actuators such as these are known and are in use in many forms and embodiments in the prior art. In this case, it is known for all forms of actuators, electric motors and transmissions to be fitted with widely differing sensors which, for example, can permanently determine and output the performance data during operation, such as the temperature, ageing, rotation speed or torque, or the like.

With conventional actuators, this requires a high degree of control complexity, which is expensive and complex to provide and furthermore requires appropriate closed-loop and open-loop control devices which, because of their heavy weight, are also particularly undesirable in the field of aviation.

Furthermore, actuators such as these require highly complex control systems, which are expensive to develop, to operate and to maintain.

The present invention is based on the object of providing an actuator of the type mentioned initially which overcomes the stated disadvantages, and by means of which a desired actuator can be selected exactly and on a user-specific basis, in a very simple and cost-effective manner.

### SUMMARY OF THE INVENTION

This object is achieved by the actuator having at least one associated electronic name plate.

In the case of the present invention, it has been found to be particularly advantageous for the performance data of an appliance to be determined experimentally exactly after its manufacture, in particular before installation of an actuator, and for the actuator-specific data for each actuator itself to be stored in an electronic name plate in the form of a simplified form, as a factor. In this case, it has been found to be advantageous to choose a factor which forms a ratio of the torque to the current and rated rotation speed.

In this way, the actual characteristic for each individual actuator itself can be determined experimentally on an actuator-specific basis.

This is required for each individual actuator even during series manufacture of actuators, since each actuator, including those produced in series manufacture, has different characteristic data in terms of torque, current draw, rated rotation speed and thus torque constant etc., as a result of manufacturing tolerances, storage times, etc.

Knowledge of this data on an actuator-specific basis is of major importance for determination and control of the actuator during operation, in terms of a minimum torque and in order to limit the maximum permissible torque, since this allows each actuator itself to be used and installed on a user-specific basis by means of its own characteristic data, and allows it to be driven and controlled on the basis of its characteristic data in such a way as to achieve the exact minimum torque and to appropriately limit and not exceed the exact maximum torque.

In this case, the electronic name plate can be associated with or integrated in the plug element itself, in the actuator, in the housing of the actuator, in the electronic drive or in the transmission as a readable chip or the like and can be evaluated by the plug elements or can be evaluated without the use of wires, although the invention is not restricted to this.

### BRIEF DESCRIPTION OF THE DRAWINGS

Further advantages, features and details of the invention will become evident from the following description of one preferred exemplary embodiment and on the basis of the drawings, in which:

FIG. 1 shows a schematically illustrated perspective side view of an actuator;

FIG. 2 shows a schematically illustrated perspective rear view of the actuator shown in FIG. 1;

FIG. 3 shows a schematically illustrated side view of the actuator shown in FIGS. 1 and 2;

FIG. 4 shows a schematically illustrated rear view of the actuator R as shown in FIG. 1.

### DETAILED DESCRIPTION

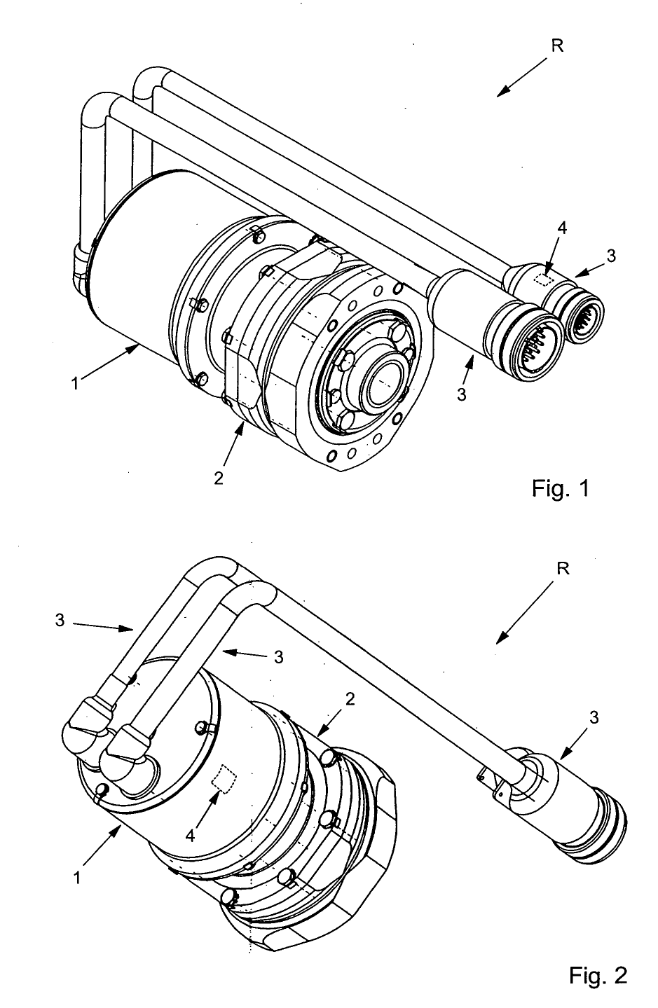

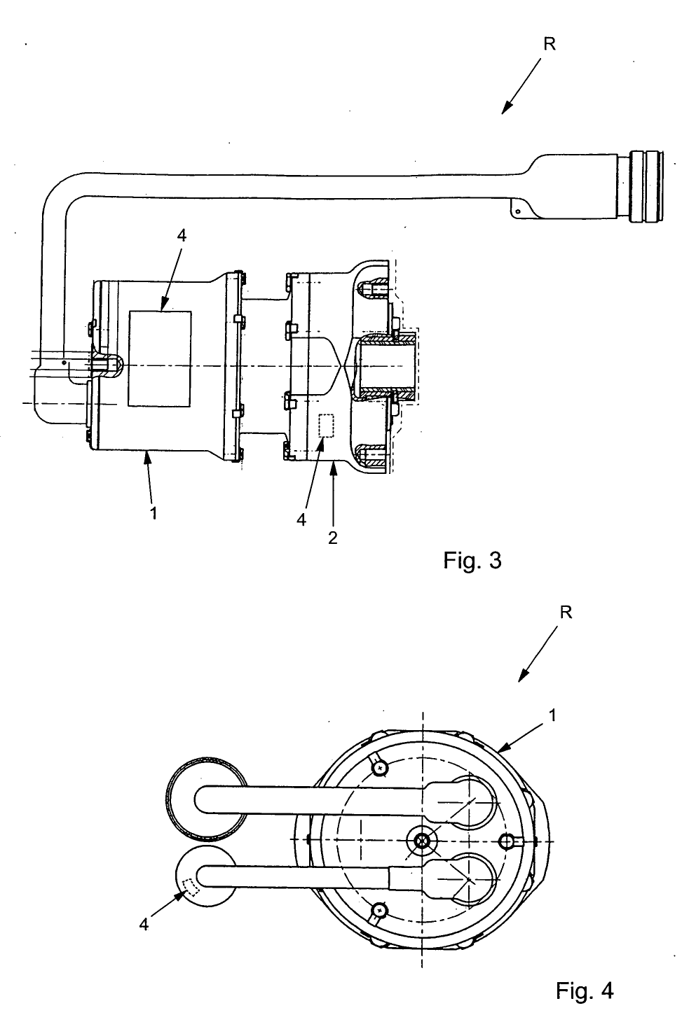

As shown in FIG. 1, an actuator R has an electrical drive 1 which is followed by a transmission 2.

In order to drive the electrical drive 1, plug elements 3 project into the electrical drive 1, preferably projecting into the electrical drive 1 at the rear.

In the case of the present invention, it has been found to be particularly advantageous for the actuator R to have an associated electronic name plate 4.

In this case, the electronic name plate 4 can be integrated in one of the two plug elements 3, and can be associated with and/or connected to the electrical drive 1 and/or the transmission 2.

The electronic name plate 4 is preferably used integrated in one of the two plugs 3, and can also be evaluated, or is arranged such that it can be read, there via the plug element 3.

In the present invention, actuator-specific data is stored in the electronic name plate 4.

Exact characteristic data for the actuator R itself is stored in the name plate 4 there.

In this case, each individual appliance or each individual actuator R is tested in its own right after manufacture and before installation, and this correspondingly determined characteristic data for the actuator R is stored in the actuator's own name plate 4 there. In the case of the present invention, it has been found to be particularly advantageous for the specific characteristic data for that actuator R itself to be stored in the form a so-called “KT” factor in the electronic name plate 4, with this KT factor being formed from a ratio of the torque to the current as a function of the rotation speed or rated rotation speed of the electrical drive 1 and/or of the transmission 2.

If required, it is also possible to influence a correction for the “KT” factor and/or the ratio of the torque to the current as a function of the rotation speed by the addition of a correction factor by, for example, the temperature. This is likewise intended to be within the scope of the present invention. In this case, the transmission 2 and/or the electrical drive 1 have/has an associated additional temperature sensor which provides the appropriate data for this purpose.

However, one important factor of the present invention is that the specific characteristic data for each actuator R is determined individually and specifically highly exactly, in order to obtain an actuator R whose power can be determined exactly. In this case, before the installation of the actuator R for any given user, for example for opening and closing doors in the field of aviation, the actuator R is tested on load, and the exact measured characteristic data resulting from this can be stored in the form of the “KT” factor from the ratio/torque to current as a function of the rotation speed in the electronic name plate 4. This allows the actuator to be driven very easily, exactly and accurately with torques which can be defined precisely.

Furthermore, it is necessary to reduce ageing, wear and in particular user-specific use of the actuator R at a specific point of use which, for example, requires a minimum torque in a highly sensitive manner, without it being possible to exceed a maximum torque. This is of particular importance, for example, in the field of aviation, in particular for electrical opening and closing of doors, so that the structure of the aircraft, of the aircraft door or the like is not damaged by the maximum permissible torque being exceeded.

1. Actuator, comprising an electrical drive (1) with a downstream transmission (2), in particular for automatic and electrical closure of doors of a vehicle, in particular of an aircraft,
characterized
in that the actuator (R) has at least one associated electronic name plate (4).

2. Actuator according to claim 1, wherein actuator-specific characteristic data is stored in the electronic name plate (4).

3. Actuator according to claim 1, wherein the exactly determined characteristic data of the actuator (R) itself is stored in the electronic name plate (4).

4. Actuator according to claim 1, wherein the respective specific, exactly determined, characteristic data is stored in the electronic name plate (4) by means of appropriate experiments, as well as measurements of each individual actuator (R) itself.

5. Actuator according to claim 1, wherein the actuator's own specific characteristic data is measured, determined or determined by means of experiments and tests, and load tested immediately before installation of the actuator (R), and can then be stored on an actuator-specific basis in the electronic name plate (4) for each individual actuator (R) itself.

6. Actuator according to claim 1, wherein characteristic values, in particular factors as “KT” factors, are stored in the electronic name plate (4), in which case a ratio of the torque as a function of the current and the rotation speed can be stored as a factor.

7. Actuator according to claim 1, wherein a ratio of torques to the current as a function of the applied rotation speed can be stored as a factor in the electronic name plate (4), on an actuator-specific or appliance-specific basis, and in each case individually, thus allowing the appliance to be used on user-specific basis by means of the exactly determined factor, in an exactly controllable manner with respect to the torque to be produced in the actuator (R).

8. Actuator according to claim 1, wherein the electronic name plate (4) is associated with the electrical drive (1) and/or the downstream transmission (2) and/or a plug element (3), or is integrated there.

9. Actuator according to claim 1, wherein only the specific KT factor for that appliance can be read from the electronic name plate (4) as the ratio between the torque and current as a function of the rotation speed, with the emitted torque being driven and controlled exactly by means of this data.

10. Actuator according to claim 6, wherein after determination of a factor for that specific actuator, a minimum requirement for a torque and a maximum permissible torque of the actuator (R) can be controlled exactly during operation on a user-specific basis for one specific application.
